(19) United States
(12) Patent Application Publication
(10) Pub. No.: US 2018/0126854 A1
(43) Pub. Date: May 10, 2018

(54) VEHICLE-MOUNTED SOLAR CELL DEVICE AND SYSTEM

(71) Applicant: BOE TECHNOLOGY GROUP CO., LTD., Beijing (CN)

(72) Inventors: Bo ZHANG, Beijing (CN); Wenbo LI, Beijing (CN)

(73) Assignee: BOE TECHNOLOGY GROUP CO., LTD., Beijing (CN)

(21) Appl. No.: 15/532,500

(22) PCT Filed: Nov. 17, 2016
(86) PCT No.: PCT/CN2016/106280

§ 371 Date: Jun. 1, 2017

(30) Foreign Application Priority Data
Jun. 15, 2016 (CN) 201610426027.6

(51) Int. Cl. B60L 8/00; H02S 10/40

(52) U.S. Cl. CPC B60L 8/003; B60K 2016/003; Y02T 10/90; H02S 10/40

(57) ABSTRACT

The present disclosure provides a solar cell device for mounting over a movable object, which includes a housing and a solar panel. The housing is disposed on an outer surface of the movable object. The solar panel is disposed inside the housing. The housing is provided with an openable cover, configured to allow the solar panel to expose to an external environment to thereby generate electricity if opened and to shield the solar panel from the external environment if closed. Herein the movable object can be a vehicle, a train, a ship or an airplane.

### CROSS-REFERENCE TO RELATED APPLICATION

The present application claims priority to Chinese Patent Application No. 201610426027.6 filed on Jun. 15, 2016, the disclosure of which is hereby incorporated by reference in its entirety.

### TECHNICAL FIELD

The present disclosure is related generally to the technologies of vehicle-mounted devices, and more specifically to a vehicle-mounted solar cell device and system.

### BACKGROUND

Currently, with the energy shortage world-wide, many countries are vigorously developing technologies in new energy, and solar cells represent one important new energy technology. Due to the large energy consumption by vehicles, the development of vehicle-mounted solar cells has become a top priority. Typically, at least one solar panel having single crystalline silicon solar cells can be installed on a roof of a car, and can provide about 200 watts of electric energy, which is sufficient to drive a vehicle-mounted air conditioner, thus having significant energy savings.

In conventional technologies, the solar panels are typically installed on the roof of vehicles by attach mounting, which affects the appearance of vehicles, and results in a poor mounting security. In addition, when the vehicle is in a harsh environment, such as in a rain, snow, and hail, the solar panels exposed outside the vehicles may incur damages, negatively affecting the life of solar panels.

### SUMMARY

In order to address the issues mentioned above that are associated with conventional technologies, the present disclosure provides a vehicle-mounted solar cell device and system.

In a first aspect, a solar cell device for mounting over a movable object is disclosed herein, which includes a housing and a solar panel. The housing is disposed on an outer surface of the movable object. The solar panel is disposed inside the housing. The housing is provided with an openable cover, configured to allow the solar panel to expose to an external environment to thereby generate electricity if opened and to shield the solar panel from the external environment if closed.

Herein the movable object can be a vehicle, a ship, an airplane, a train, etc. There are no limitations herein. The outer surface of the movable object can be a top cover of the vehicle, but can also be a side cover that can faces the sun.

In some embodiments of the solar cell device, the housing can be embedded in a top cover of the movable object to thereby substantially reduce a wind resistance during moving of the movable object. The housing can be an integrated part of a top cover of the movable object.

The openable cover can be of a swing-door type, a sliding-door type, or a folding-door type, but can also be of a combination of these types.

In some embodiments the solar cell device, the openable cover is of a swing-door type, and the openable cover comprises at least one cover piece. Each of the at least one cover piece is configured to be hingedly connected with a sidewall of the housing to thereby allow opening or closing of the openable cover.

In the solar cell device as such, the openable cover can comprise two cover pieces, each configured to be opened or closed along either a length direction or a width direction of the movable object.

In yet some other embodiments the solar cell device, the openable cover can be of a sliding-door type and can include a plurality of cover boards, which are configured to be slidably connected with one another to thereby allow opening or closing of the openable cover.

In yet some other embodiments the solar cell device, the openable cover can be of a folding-door type and can include a plurality of cover plates, which are configured to be hingedly connected with one another to thereby allow foldingly opening or unfoldingly closing of the openable cover.

According to some embodiments of the present disclosure, the solar cell device can further include a converter, which is configured to convert the electricity generated by the solar panel to a power supply compatible with at least one electrical device in the movable object.

In some embodiments the solar cell device, the openable cover is transparent, and as such can have a composition of at least one of acrylic or polycarbonate.

In a second aspect, the present disclosure provides a power supply system, which includes a solar cell device according to any one of the embodiments as described above.

According to some embodiments of the present disclosure, the power supply system can further include at least one electrical device, wherein the solar cell device is electrically coupled with, and configured to supply power to, each of the at least one electrical device.

In the power supply system as described above, the solar cell device can be configured to supply power to the at least one electrical device in a wired, or wireless manner, and there are no limitations herein.

In the embodiments where the solar cell device is configured to supply power to the at least one electrical device in a wireless manner, the power supply system can further include at least one wireless charger. Each of the at least one wireless charger can be configured to supply power to at least one wireless charging-compatible electrical device.

The power supply system can further comprise a processor, wherein the processor is respectively coupled to the solar cell device and each of the at least one electrical device, and is configured to control a supply of power from the solar cell device to each of the at least one electrical device.

In the power supply system as described above, a communication portion can be further included, wherein the communication portion is coupled with the processor and at least one terminal and is configured to mediate a communication between the processor and each of the at least one terminal to thereby allow the at least one terminal to monitor and/or control each of the at least one electrical device in the movable object. The communication portion can be a wireless communication portion, and the at least one terminal can include at least one mobile terminal.

In a third aspect, the present disclosure provides a vehicle, which comprises a power supply system according to any one of the embodiments as described above.

Other embodiments may become apparent in view of the following descriptions and the attached drawings.

### BRIEF DESCRIPTION OF THE DRAWINGS

To more clearly illustrate some of the embodiments, the following is a brief description of the drawings. The drawings in the following descriptions are only illustrative of some embodiments. For those of ordinary skill in the art, other drawings of other embodiments can become apparent based on these drawings.

FIG. 1 is a schematic diagram of a vehicle-mounted solar cell device (with an openable cover opened) according to a first embodiment of the present disclosure;

FIG. 2 is a schematic diagram of the vehicle-mounted solar cell device (with the openable cover closed) according to the first embodiment of the present disclosure;

FIGS. 3A and 3B are respectively a top view of the vehicle-mounted solar cell device (with the openable cover closed) according to some other embodiments of the present disclosure;

FIG. 4 is a schematic diagram of a vehicle-mounted solar cell device (with an openable cover opened) according to a second embodiment of the present disclosure;

FIG. 5 is a schematic diagram of a vehicle-mounted solar cell device (with an openable cover closed) according to a second embodiment of the present disclosure;

FIG. 6 is a schematic diagram of a vehicle-mounted solar cell device (with an openable cover half-opened) according to a third embodiment of the present disclosure;

FIG. 7 is a schematic diagram of a vehicle-mounted power supply system according to some embodiments of the present disclosure;

FIG. 8 is a schematic diagram of a vehicle-mounted power supply system having at least one wireless charger according to a third embodiment of the present disclosure.

### DETAILED DESCRIPTION

In the following, with reference to the drawings of various embodiments as disclosed herein, the technical solutions of the embodiments of the disclosure will be described in a clear and fully understandable way.

It is obvious that the described embodiments are merely a portion but not all of the embodiments of the disclosure. Based on the described embodiments of the disclosure, those ordinarily skilled in the art can obtain other embodiment(s), which come(s) within the scope sought for protection by the disclosure.

In order to improve the mounting security of a vehicle-mounted solar cell device and to prolong its service life, the present disclosure provides a vehicle-mounted solar cell device, a vehicle-mounted power supply system, and a vehicle provided with the vehicle-mounted solar cell device and power supply system.

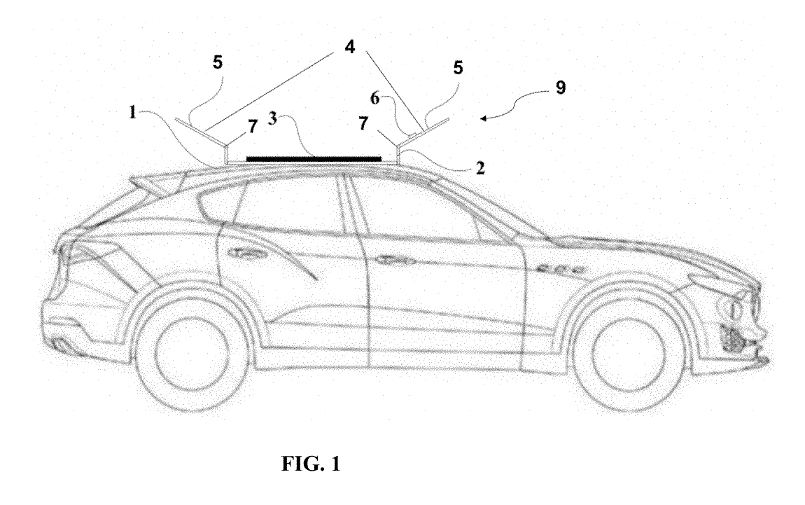

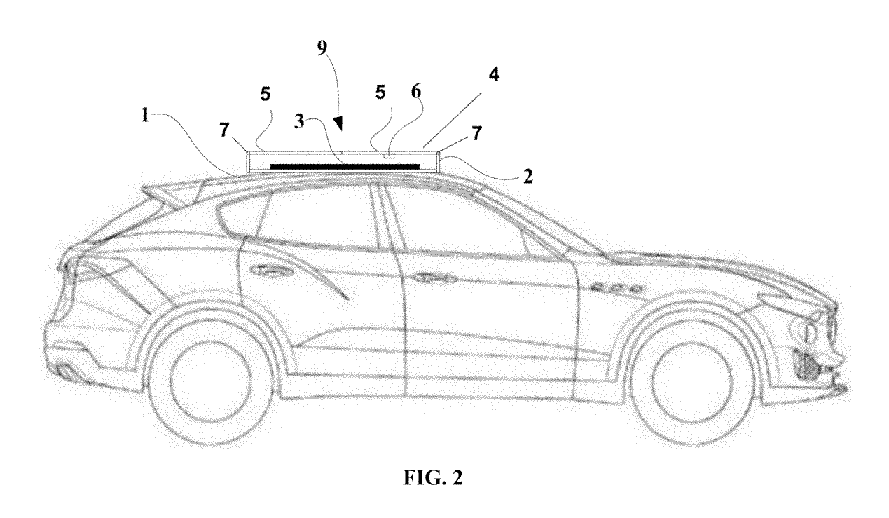

FIGS. 1 and 2 illustrate a vehicle-mounted solar cell device according to a first embodiment of the present disclosure. As shown in the figures, the vehicle-mounted solar cell device 9 includes a housing 2, and a solar panel 3. The housing 2 is fixedly mounted on a top cover 1 of a vehicle. The solar panel 3 is securely disposed in the housing 2. The housing 2 is provided with an openable cover 4.

There are multiple methods to fixedly mount the housing 2 on the top cover 1 of the vehicle. For example, a set of fasteners, including screws, nuts, or studs, can be employed for mounting the housing 2 on the top cover 1 of the vehicle. The housing 2 can be embedded in the top cover 1, or can protrude from the top cover 1. There are no limitations herein.

The housing 2 is preferably made with a material, a shape and a color that are configured to be compatible with the vehicle top cover. The housing 2 can be manufactured during the vehicle production process by, for example, a compression molding process over the vehicle bodies. There are no limitations herein.

In a preferred embodiment, it can be configured such that when the openable cover 4 is closed, the housing 2 is integrated into the body of the vehicle, which can thus allow the vehicle to have a beautiful outer appearance, and can also help reduce the wind resistance (i.e. increase the aerodynamically efficiency) of the vehicle during moving.

In the vehicle-mounted solar cell device as described above, the housing 2 is fixedly mounted on the top cover 1 of the vehicle, and the solar panel 3 is securely disclosed in the housing 2. Compared with current technologies, this configuration can increase the mounting security of the vehicle-mounted solar cell device.

If the weather and external environment allows, the openable cover 4 can be opened (i.e. in an OPEN status) to thereby allow the normal working of the solar panel 3 to generate electricity for supply to the vehicle.

Under situations such as during nighttime, in a rain, in a snow, in a hail, or if the external environment is not sufficiently safe, the openable cover 4 can be closed. Consequently, the solar panel 3 of the vehicle-mounted solar cell device 9 stops working, and the openable cover 4 that is closed (i.e. in a CLOSE status) can shield or protect the solar panel 3 from the external environment, thereby capable of prolonging the service life of the solar panel 3 and the vehicle-mounted solar cell device 9.

In the present disclosure, there are no limitations regarding the detailed structure, size, and mechanisms of the openable cover 4. For example, the openable cover 4 can be of a swing-door type, a sliding-door type, or a folding-door type.

In the first embodiment as shown in FIGS. 1 and 2, the openable cover 4 is of a swing-door type, which comprises two cover pieces 5, each rotatably connected with a sidewall of the housing 2 through a hinge 7.

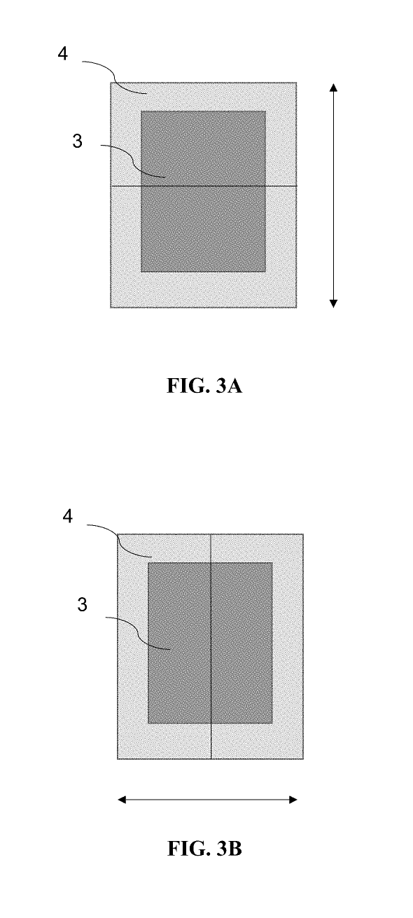

The two cover pieces 5 of the openable cover 4 are configured to be opened or closed along either a length direction (as shown in FIG. 3A) or a width direction (as shown in FIG. 3B) of the vehicle. Herein the width/length direction is referred to as the direction of the hinges 7 of the openable cover 4 along which the openable cover 4 is swung to open or close.

It shall be noted that besides the configuration as shown in FIGS. 1, 2, 3A, and 3B, where two parallel hinges 7 are applied to rotatably connect each of the two cover pieces 5 of the openable cover 4 with two sidewalls of the housing 2, there are other possible configurations having different number of cover pieces and hinges, and different directions for opening and closing each of the cover pieces of the openable cover 4. For example, there can be only one cover piece for the openable cover 4, which is configured to rotatably connect with one sidewall of the housing 2 through only one hinge. There are no limitations herein.

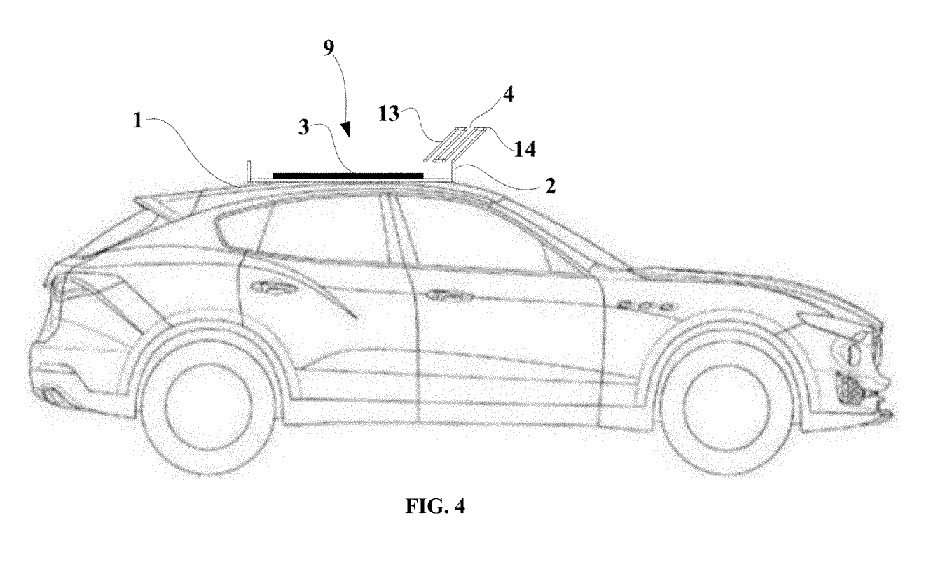

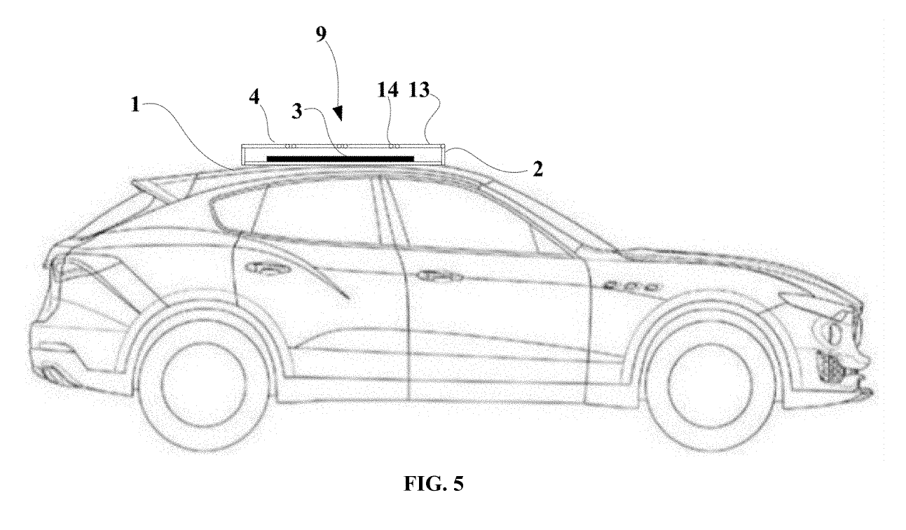

FIG. 4 and FIG. 5 illustrate a vehicle-mounted solar cell device according to a second embodiment of the present disclosure, where an openable cover 4 of the vehicle-mounted solar cell device 9 is of a folding-door type.

As shown in FIGS. 4 and 5, in this second embodiment of the vehicle-mounted solar cell device 9, the openable cover 4 comprises a plurality of cover plates 13, hingedly connected with one another through pins 14 (i.e. one cover plate is hingedly connected with a neighboring cover plate through a pin 14 to allow folding and unfolding of the two cover plates).

When there is a need to use the vehicle-mounted solar cell device 9, the plurality of cover plates 13 of the retract the openable cover 4 can be folded to thereby expose, and allow the normal working of, the solar panel 3, as illustrated in FIG. 4.

When the vehicle is at situations such as during nighttime, in a rain, in a snow, in a hail, or if the external environment is not sufficiently safe, the plurality of cover plates 13 of the retract the openable cover 4 can be unfolded to thereby shield the solar panel 3 from the external environment, as illustrated in FIG. 5.

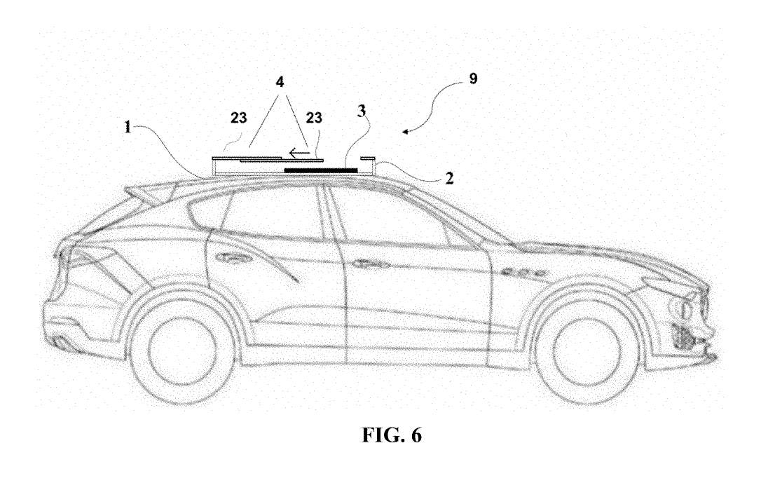

FIG. 6 illustrates a vehicle-mounted solar cell device according to a third embodiment of the present disclosure, where an openable cover 4 of the vehicle-mounted solar cell device 9 is of a sliding-door type.

In this third embodiment of the vehicle-mounted solar cell device 9, the openable cover 4 comprises a plurality of cover boards 23, slidably connected with one another (i.e. one slidable cover board is connected with a neighboring cover board and is configured such that these two cover boards can slide towards or away from each other).

In FIG. 6, the openable cover 4 is half-opened. If the openable cover 4 is pushed along a direction of the arrow (i.e. the cover board 23 on the right is pushed to slide leftwards), the openable cover 4 can be opened to thereby expose, and allow the normal working of, the solar panel 3. On the contrary, if the openable cover 4 is pushed along an opposite direction of the arrow (i.e. the cover board 23 on the right is pushed to slide rightwards), the openable cover 4 is closed to thereby shield the solar panel 3 from the external environment.

As shown in FIGS. 1 and 2, the vehicle-mounted solar cell device 9 can further include a converter 6, which is configured to convert the electric energy generated by the solar panel 3 to meet the requirement of the power supply of the vehicle.

This configuration can increase a usable internal space for the housing 2, as such portions other than the solar panel 3 and the electric circuit portion 6 can also be installed on an inner side of the openable cover plate 4, further optimizing the layout of various portions insides the housing 2.

In some preferred embodiments, the openable cover 4 can be transparent, and thus can have a transparent composition such as acrylic or polycarbonate. A UV light has a good penetrability through a transparent openable cover 4 having a composition of acrylic or polycarbonate. As such, when the weather condition is good, having sufficient ultraviolet radiation, the openable cover 4 does not need to be opened for the solar panel 3 to work.

In another aspect, the present disclosure provides a vehicle-mounted power supply system.

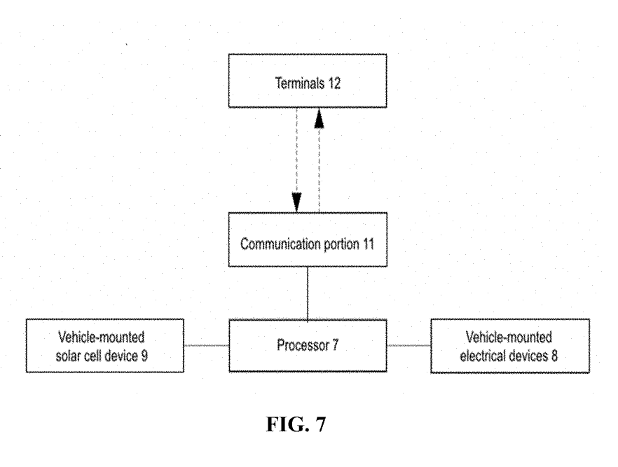

As shown in FIG. 7, the vehicle-mounted power supply system comprises a processor 7, at least one electrical device 8, and a vehicle-mounted solar cell device 9 according to any embodiment as described above. The processor 7 and the at least one electrical device 8 are each mounted in the vehicle.

The processor 7 is coupled to the vehicle-mounted solar cell device 9 and each of the at least one electrical device 8 respectively, and is configured to control the power supply from the vehicle-mounted solar cell device 9 to each of the at least one electrical device 8.

The at least one electrical device 8 can be a vehicle-mounted device such as a car battery, a car charger, a vehicle air conditioner, a display screen, a car lamp or an audio player, and can be other vehicle-mounted electrical devices that requires power supply. There are no limitations herein.

The power supply from the vehicle-mounted solar cell device 9 to each of the at least one electrical device 8 can be in a wired manner, or in a wireless manner. In other words, the vehicle-mounted solar cell device 9 can be coupled to, and configured to supply power to, each of the at least one electrical device 8 in a wired and/or a wireless manner.

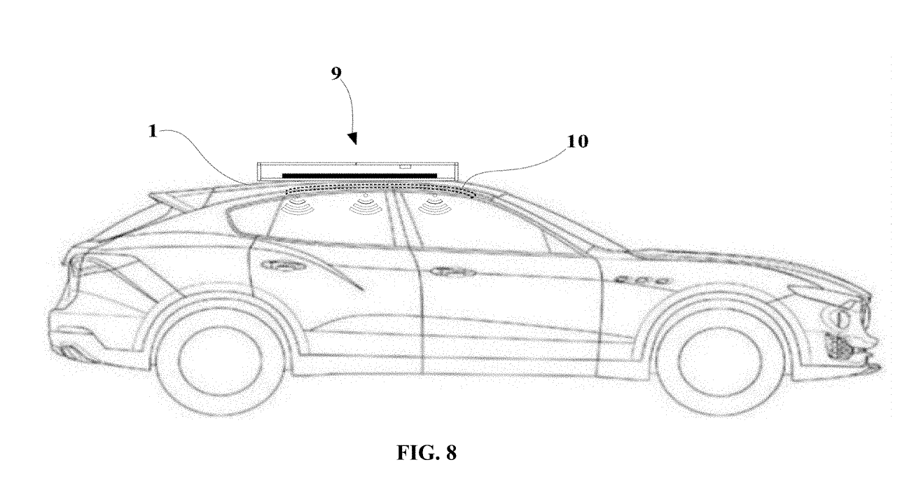

In some embodiments of the present disclosure as shown in FIG. 8, the vehicle-mounted solar cell device 9 is configured to supply power to, a first subset of the at least one electrical device 8 in a wireless manner. As illustrated in FIG. 8, the power supply from the vehicle-mounted solar cell device 9 to the first subset of the at least one electrical device 8 can be mediated through at least one wireless charger 10.

A wireless charger 10 can be disposed on an inner side of the top cover 1 of the vehicle, configured to charge an electrical device compatible with wireless charging within a workable range of radiation. In addition, a wireless charger 10 can also be disposed somewhere else in the vehicle, such as a control panel in the front, or in the middle, of the vehicle. There are no limitations herein.

In some other embodiments of the present disclosure (not shown in the drawings), the vehicle-mounted solar cell device 9 is configured to supply power to, a second subset of the at least one electrical device 8 in a wired manner. As such, the vehicle-mounted power supply system can further comprise at least one power cord. The at least one power cord is configured to electrically couple the vehicle-mounted solar cell device 9 with each of the second subset of the at least one electrical device 8.

By means of the vehicle-mounted power supply system as described above, the solar energy can be transformed into an environment-friendly power that is supplied to the electrical devices on a vehicle. As such, the environment is protected, and the energy is saved. Compared with the existing technologies, the vehicle-mounted solar cell device in the vehicle-mounted power supply system has additional advantages such as a high mounting security and a long service life.

As illustrated in FIG. 7, the vehicle-mounted power supply system can further include a communication portion 11, which is coupled with the processor 7 and configured to communicate with at least one terminal 12 to thereby allow the at least one terminal 12 to get information of, and to control the working of, each of the at least one electrical device 8 in the vehicle. This configuration as such can greatly increase the degree of intelligence for the vehicle, and can bring more convenience to vehicle users.

The communication portion 11 can be coupled with the at least one terminal 12 in a wired or wireless manner. In a preferred embodiment, the communication portion 11 can be coupled with the at least one terminal 12 wirelessly, and as such, the communication portion 11 can be a wireless communication portion, and the at least one terminal 12 can be a mobile terminal.

As such, a processor can obtain data from each of vehicle-mounted electrical devices, as well as from a vehicle-mounted solar cell device, in a real-time manner, and can in turn control the working of each electrical device and the vehicle-mounted solar cell device. The processor can also communicate with a mobile phone via a wireless communication portion, and in turn, a user using the mobile phone can obtain the data from, and control the working of each electrical device and the vehicle-mounted solar cell device in a remote manner. For example, through an application (APP) in his/her own cell phone, the user can remotely control to start a vehicle air conditioner before the engine is started in a hot day.

In a third aspect, the present disclosure provides a vehicle, which includes a vehicle-mounted solar cell device according to any of the embodiments as described above.

In some embodiments of the present disclosure, the vehicle further comprises a processor and at least one electrical device. The processor is respectively coupled to the vehicle-mounted solar cell device 9 and each of the at least one electrical device, and is configured to control a supply of power from the vehicle-mounted solar cell device 9 to each of the at least one electrical device.

In some embodiments of the present disclosure, the vehicle further comprises a wireless communication portion, which is coupled to, and configured to communicate with, at least one mobile terminal.

For the vehicle as described above, the solar energy can be transformed into an environment-friendly power that is supplied to the electrical devices mounted thereon. As such, the environment is protected, and the energy is saved. The vehicle has additional advantages such as a high mounting security and a long service life.

The vehicle can be a passenger car, an SUV (sports utility vehicle), or a bus. There are no limitations herein.

All references cited in the present disclosure are incorporated by reference in their entirety. Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A solar cell device for mounting over a movable object, comprising:
a housing, disposed on an outer surface of the movable object; and
a solar panel, disposed inside the housing;
wherein:
the housing is provided with an openable cover, configured to allow the solar panel to expose to an external environment to thereby generate electricity if opened and to shield the solar panel from the external environment if closed.

2. The solar cell device of claim 1, wherein the movable object is a vehicle, a train, a ship, or an airplane.

3. The solar cell device of claim 1, wherein the housing is embedded in a top cover of the movable object to thereby substantially reduce a wind resistance during moving of the movable object.

4. The solar cell device of claim 1, wherein the housing is an integrated part of a top cover of the movable object.

5. The solar cell device of claim 1, wherein the openable cover is of at least one of a swing-door type, a sliding-door type, or a folding-door type.

6. The solar cell device of claim 5, wherein the openable cover is of a swing-door type and comprises at least one cover piece, each configured to be hingedly connected with a sidewall of the housing to thereby allow opening or closing of the openable cover.

7. The solar cell device of claim 6, wherein the openable cover comprises two cover pieces, each configured to be opened or closed along either a length direction or a width direction of the movable object.

8. The solar cell device of claim 5, wherein the openable cover is of a sliding-door type and comprises a plurality of cover boards, configured to be slidably connected with one another to thereby allow opening or closing of the openable cover.

9. The solar cell device of claim 5, wherein the openable cover is of a folding-door type and comprises a plurality of cover plates, configured to be hingedly connected with one another to thereby allow foldingly opening or unfoldingly closing of the openable cover.

10. The solar cell device of claim 1, further comprising a converter, configured to convert the electricity generated by the solar panel to a power supply compatible with at least one electrical device in the movable object.

11. The solar cell device of claim 1, wherein the openable cover is transparent.

12. The solar cell device of claim 11, wherein the openable cover has a composition of at least one of acrylic or polycarbonate.

13. A power supply system, comprising a solar cell device according to claim 1.

14. The power supply system of claim 13, further comprising at least one electrical device, wherein:
the solar cell device is electrically coupled with, and configured to supply power to, each of the at least one electrical device.

15. The power supply system of claim 14, wherein the solar cell device is configured to supply power to the at least one electrical device at least in a wireless manner.

16. The power supply system of claim 15, further comprising at least one wireless charger, each configured to supply power to at least one wireless charging-compatible electrical device.

17. The power supply system of claim 14, further comprising a processor, wherein:
the processor is respectively coupled to the solar cell device and each of the at least one electrical device, and is configured to control a supply of power from the solar cell device to each of the at least one electrical device.

18. The power supply system of claim 17, further comprising a communication portion, wherein:
the communication portion is coupled with the processor and at least one terminal and is configured to mediate a communication between the processor and each of the at least one terminal to thereby allow the at least one terminal to monitor and/or control each of the at least one electrical device in the movable object.

19. The power supply system of claim 18, wherein the communication portion is a wireless communication portion, and the at least one terminal comprises at least one mobile terminal.

20. A vehicle, comprising a power supply system according to claim 13.
